(19) United States
(12) Patent Application Publication
(10) Pub. No.: US 2016/0088441 A1
(43) Pub. Date: Mar. 24, 2016

(54) WIRELESS LOCAL AREA NETWORK CHANNEL SCANNING

(71) Applicant: Qualcomm Incorporated, San Diego, CA (US)

(72) Inventors: Faraz MOHAMMAD MIRZAEI, San Jose, CA (US); Saumitra Mohan DAS, Santa Clara, CA (US); Ravi PALANKI, Cupertino, CA (US); Mona MAHMOUDI, Sunnyvale, CA (US)

(21) Appl. No.: 14/494,445

(22) Filed: Sep. 23, 2014

(51) Int. Cl. H04W 4/04; H04W 40/24

(52) U.S. Cl. CPC H04W 4/04; H04W 40/244; H04W 84/12

(57) ABSTRACT

A mobile device capable of communication with wireless access points over wireless local area network (WLAN) channels, including prevailing channels corresponding to a region and non-prevailing channels corresponding to the region, includes: a scanning module configured to passively scan each channel of a subset of channels for a beacon signal; and a control module communicatively coupled to the scanning module and configured to control which channels the scanning module passively scans such that the subset of channels comprises multiple channels of the WLAN channels but less than all of the WLAN channels, and such that the subset of channels includes at least one of the prevailing channels.

### BACKGROUND

Indoor position determination and floor determination of mobile devices presents issues not encountered outdoors. For example, indoor positioning relies on map features such as walls, partitions, infeasible areas, etc. Consequently, heatmaps may be used that take in to account such features to provide a predicted heatmap of received signal strength indication (RSSI) from WiFi access points as a function of position. A positioning engine uses RSSI or a range vector to calculate a position fix that best matches the predicted heatmap.

Heatmap information varies over time. For example, WiFi access points may be moved and/or map features (walls, partitions, stairwells, etc.) may be added, removed, altered, etc. Variations in the layout of the access points (including additions or reductions of access points) and/or the layout of the indoor space itself will affect the heatmap. Thus, heatmap information is typically acquired on a recurring basis in order to confirm/verify existing heatmaps, to improve accuracy of existing heatmaps, and/or to change heatmaps to reflect changes in the access point arrangement and/or map features. For example, crowdsourcing of information may be used where mobile devices acquire signals from the access points and provide information, for example RSSI and position information.

### SUMMARY

An example of a mobile device capable of communication with wireless access points over wireless local area network (WLAN) channels, including prevailing channels corresponding to a region and non-prevailing channels corresponding to the region, includes: a scanning module configured to passively scan each channel of a subset of channels for a beacon signal; and a control module communicatively coupled to the scanning module and configured to control which channels the scanning module passively scans such that the subset of channels comprises multiple channels of the WLAN channels but less than all of the WLAN channels, and such that the subset of channels includes at least one of the prevailing channels.

Implementations of such a mobile device may include one or more of the following features. The control module is configured to obtain indications of frequency of use of the non-prevailing channels in a location presently associated with the mobile device, and the subset of channels includes the most-frequently-used non-prevailing channel according to the indications. The scanning module is configured to passively scan all of the prevailing channels and the N most-frequently-used non-prevailing channels according to the indications, wherein N is an integer greater than one and less than a total number of the non-prevailing channels. The control module is configured to receive a list of the non-prevailing channels and the indications of frequency of use of the non-prevailing channels. The control module is configured to select a particular one of the non-prevailing channels for the scanning module to passively scan only if the particular one of the non-prevailing channels has a frequency of use greater than a threshold frequency of use. The mobile device further includes a channel use module, communicatively coupled to the scanning module, for determining and sending signals wirelessly from the mobile device indicating which of the WLAN channels the scanning module scanned, on which of the WLAN channels that were scanned the beacon signal was received, and a MAC address associated with each beacon signal that was received. The mobile device further including channel indications stored in hardware that indicate the prevailing channels. The subset of channels includes at least one of the non-prevailing channels and wherein the scanning module is configured to passively scan the at least one of the non-prevailing channels for less than 110 ms. The scanning module is configured to continue passively scanning the channels of the subset of channels regardless of any detected beacon during scanning of a channel of the subset of channels

Another example of a mobile device capable of communication with wireless access points over wireless local area network (WLAN) channels, including prevailing channels corresponding to a region and non-prevailing channels corresponding to the region, includes: scanning means for passively scanning each channel of a subset of channels for a beacon signal; and control means, communicatively coupled to the scanning means, for controlling which channels the scanning means passively scans such that the subset of channels comprises multiple channels of the WLAN channels but less than all of the WLAN channels, and such that the subset of channels includes at least one of the prevailing channels.

Implementations of such a mobile device may include one or more of the following features. The control means are configured to obtain indications of frequency of use of the non-prevailing channels in a location presently associated with the mobile device, and wherein the subset of channels includes the most-frequently-used non-prevailing channel according to the indications. The scanning means are configured to passively scan all of the prevailing channels and the N most-frequently-used non-prevailing channels according to the indications, wherein N is an integer greater than one and less than a total number of the non-prevailing channels. The scanning means are configured to passively scan a particular one of the non-prevailing channels only if the particular one of the non-prevailing channels has a frequency of use greater than a threshold frequency of use. The mobile device further including channel use means, communicatively coupled to the scanning means, for determining and transmitting signals wirelessly from the mobile device indicative of which of the WLAN channels the scanning means scanned, on which of the WLAN channels that were scanned the beacon signal was received, and a MAC address associated with each beacon signal that was received. The subset of channels includes at least one of the non-prevailing channels and wherein the scanning means are for passively scanning the at least one of the non-prevailing channels for less than 110 ms.

An example of a method of scanning WLAN channels at a mobile device includes: passively scanning, at the mobile device, each channel of a subset of channels for a beacon signal, the subset of channels comprising multiple, but less than all, of wireless local area network (WLAN) channels, the WLAN channels including prevailing channels corresponding to a region and non-prevailing channels corresponding to the region, and the subset of channels including at least one of the prevailing channels.

Implementations of such a method may include one or more of the following features. The method further includes obtaining indications of frequency of use of the non-prevailing channels in a location presently associated with the mobile device, wherein the subset of channels includes the most-frequently-used non-prevailing channel according to the indications. The passively scanning comprises passively scanning all of the prevailing channels and the N most-frequently-used non-prevailing channels according to the indications, wherein N is an integer greater than one and less than a total number of the non-prevailing channels. The passively scanning comprises passively scanning a particular one of the non-prevailing channels only if the particular one of the non-prevailing channels has a frequency of use greater than a threshold frequency of use. Obtaining indications of frequency of use of the non-prevailing channels comprises receiving a list of the non-prevailing channels and the indications of frequency of use of the non-prevailing channels. The method further includes wirelessly transmitting signals, from the mobile device, indicative of which of the WLAN channels were scanned, on which of WLAN channels that were scanned the beacon signal was received, and a MAC address associated with each beacon signal that was received. The subset of channels includes at least one of the non-prevailing channels and wherein the passively scanning comprises passively scanning the at least one of the non-prevailing channels for less than 110 ms. The method further comprising at least one of: selecting the subset of channels before passively scanning any of the subset of channels; or defining the subset of channels by terminating the passively scanning, after the subset of channels has been passively scanned, in response to a time available for passively scanning expiring. The passively scanning is performed for all of the channels of the subset of channels regardless of any detected beacon during passive scanning of a channel of the subset of channels

An example of a server for determining crowd-sourced WLAN channel frequency of use includes: a communication interface configured to receive information from mobile devices; and a channel use determination module communicatively coupled to the communication interface and configured to: receive, from the mobile devices via the communication interface, indications of use of WLAN channels including at least non-prevailing channels; compile the indications of use of the WLAN channels to determine indications of frequencies of use of the WLAN channels.

Implementations of such a server may include one or more of the following features. The channel use determination module is configured to compile the indications of frequencies of use of the WLAN channels according to location regions. The server further includes a channel use distribution module communicatively coupled to the communication interface and to the channel use determination module and configured to send the indications of frequencies of use of the WLAN channels for a particular location region of the location regions to mobile devices disposed in the particular location region. The WLAN channels include prevailing channels. The indications of frequencies of use comprise at least one of indications of frequencies of use of the WLAN channels relative to a reference frequency, indications of frequencies of use of the WLAN channels relative to a frequency of one of the WLAN channels, or a prioritized list of the WLAN channels. Each of the indications of use of the WLAN channels includes an indication of the WLAN channel used, an indication of time of use of the WLAN channel, and an identifier of an access point from which a beacon signal was received on the WLAN channel, and wherein the channel use determination module is configured to determine the indications of frequencies of use of the WLAN channels such that the indications of frequencies of use of the WLAN channels represent frequencies of separate beacon signal transmissions on the WLAN channels.

Items and/or techniques described herein may provide one or more of the following capabilities, as well as other capabilities not mentioned. Access point measurements may be obtained in a power-efficient manner. Mobile device battery power may be conserved. Mobile device resources may be efficiently allocated for obtaining access point signals, for example increasing or even maximizing likelihood of access point signal receipt when fewer than all possible channels are scanned. How many channels are scanned for beacon signals may be dependent upon available power. Which channels are scanned for beacon signals may be selected to improve or maximize likelihood of receipt of beacon signals. Other capabilities may be provided and not every implementation according to the disclosure must provide any, let alone all, of the capabilities discussed. Upload and download data rates may be improved, for example, by reducing amounts of time that a WiFi interface is used for passive scanning rather than uploading or downloading data.

### BRIEF DESCRIPTION OF THE DRAWINGS

FIG. 1 is a simplified diagram of a communication system.

FIG. 2 is a simplified diagram of access points and a mobile device in a structure shown in FIG. 1.

FIG. 3 is a floor plan for a floor of a structure shown in FIG. 1, showing structural features, locations of access points, and a mobile device.

FIG. 4 is a block diagram of a mobile device shown in FIG. 1.

FIG. 5 is a functional block diagram of the mobile device shown in FIG. 4.

FIG. 6 is a block diagram of a server shown in FIG. 1.

FIG. 7 is a functional block diagram of the server shown in FIG. 6.

FIG. 8 is an example of a histogram of channel use.

FIG. 9 is a block flow diagram of a process of scanning WLAN channels at a mobile device.

FIG. 10 is a block flow diagram of a process of determining crowd-sourced WLAN channel frequency of use.

### DETAILED DESCRIPTION

Techniques are provided for obtaining information for determining location information of a mobile device, especially in an indoor region. A mobile device may collect information for use in determining position of the mobile device, or another mobile device (for example, for use in producing and/or maintaining a map, referred to as a heatmap, of expected received signal strength indication (RSSI) as a function of position). The mobile device may collect the information by receiving and processing signals from wireless access points. The mobile device may receive the signals by passively scanning fewer than all of the communication channels available for use by wireless access points. For example, the mobile device may passively scan more-commonly-used channels such as one or more prevailing channels plus one or more of the most-commonly-used non-prevailing channels. The channels scanned may be based on actual frequency of use of the channels by access points in a region (e.g., venue, floor, building, campus, zip codes, calling codes, cities, states, countries, etc.) where the mobile device is presently disposed. Other examples may be implemented according to the discussion herein.

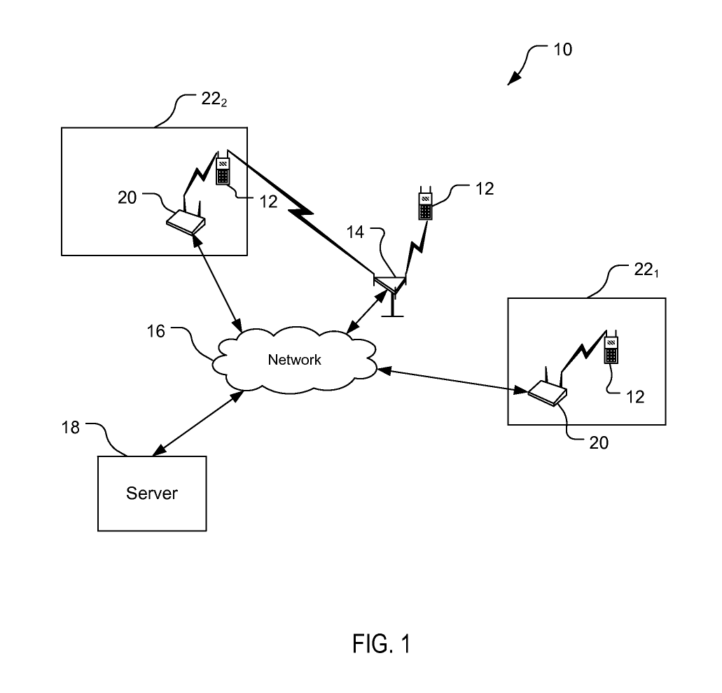

Referring to FIGS. 1-3, a communication system 10 includes mobile devices 12, a base transceiver station (BTS) 14, a network 16, a server 18, and access points (APs) 20 disposed in structures (for example, buildings) 22. The system 10 is a communication system in that the system 10 can at least send and receive communications. Although only one server 18 is shown for simplicity, more than one server 18 may be used in the system 10, for example, in various locations to provide quicker access as the system 10 may span large regions, for example entire countries or continents, or even the planet.

The BTS 14 can wirelessly communicate with the mobile devices 12 via antennas. Each of the BTSs 14 may also be referred to as an access point, an access node (AN), a Node B, an evolved Node B (Enb), etc. The BTSs 14 are configured to communicate wirelessly with the mobile devices 12 under the control of the server 18 (via the network 16).

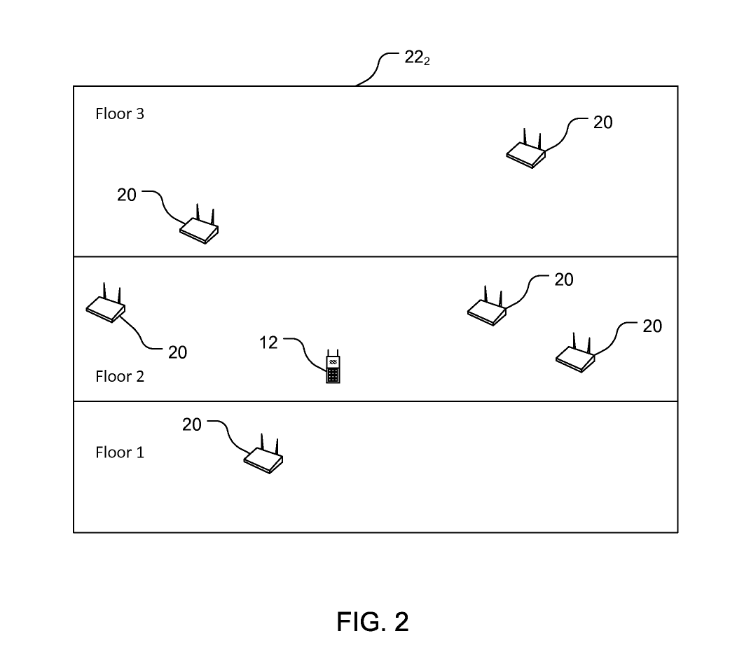

The mobile devices 12 can be moved to various locations, including into the structures 22 and onto different floors of the structures 22. The mobile devices 12 may be referred to as access terminals (ATs), mobile stations (MSs), user equipment (UE), or subscriber units. The mobile devices 12 are shown here as cellular phones. Other examples of mobile devices include wireless routers, personal digital assistants (PDAs), netbooks, notebook computers, tablet computers, etc. Only one mobile device 12 is shown in FIG. 2, and to simplify the discussion below only this mobile device 12 is discussed.

The server 18 preferably can communicate with the APs 20 within the structures 22 through the network 16, and with the mobile devices 12 through the APs 20 via the network 16 or through the BTSs 14 via the network 16. The APs 20 are preferably hard-wire connected to the network 16 through hard-wired transceivers, and include wireless transceivers for communication with the mobile devices 12 and the BTSs 14.

The APs 20 are each configured to transmit signals, such as beacon signals, over any of an available (usable) set of WiFi communication channels, i.e., wireless local area network (WLAN) channels. Several frequency bands (e.g., 2.4 GHz, 3.6 GHz, 4.9 GHz, 5 GHz, 5.9 GHz, etc.) are currently used for WiFi communications, and more may be used in the future. For 2.4 GHz WiFi, there are 14 WLAN channels, with each channel having a bandwidth of 22 MHz. Channel 1 is centered at 2.412 GHz and channels 2-13 are each centered at a frequency 5 MHz higher than the channel number immediately lower. Channel 14 is centered at 2.484 GHz. Different regions, for example countries, use different sets of the WLAN channels as prevailing channels, and consequently use different WLAN channels as non-prevailing channels (i.e., WLAN channels that are not the prevailing channels). As which channels are the prevailing and non-prevailing channels may depend upon the region (i.e., the prevailing channels and non-prevailing channels correspond to a region), they may be referred to as regionally prevailing channels and regionally non-prevailing channels. The prevailing channels are separated in frequency from each other such that interference between the channels is acceptably low. For example, in the United States, non-overlapping channels 1, 6, and 11 are the prevailing channels while in Korea channels 1, 5, 9, and 13 are the prevailing channels. For 2.4 GHz WiFi, center frequencies of channels 1 and 6, and channels 6 and 11 are separated by 25 MHz, while center frequencies of channels 1 and 5, channels 5 and 9, and channels 9 and 13 are separated by 20 MHz. Due to the desirable characteristic of little or no overlap, and the benefits this brings for communication (reduced interference compared to using channels that are closer in frequency), the prevailing channels are used for the overwhelming majority of communications. For example, the prevailing channels combined may be used for at least 70%, 80%, 90%, or even more of the total channel traffic. As another example, the prevailing channels combined may be used five, seven, ten, or even more, times as often as the non-prevailing channels combined. As another example, the lowest prevailing channel may be used distinctly more frequently than the non-prevailing channels, e.g., more than two, five, or even six times more often than the most-used non-prevailing channel. While little-used, or unused channels may be more desirable for communications, frequently-used channels can be more desirable for positioning as these channels provide more and/or more frequent information that may be used to determine position of a mobile device.

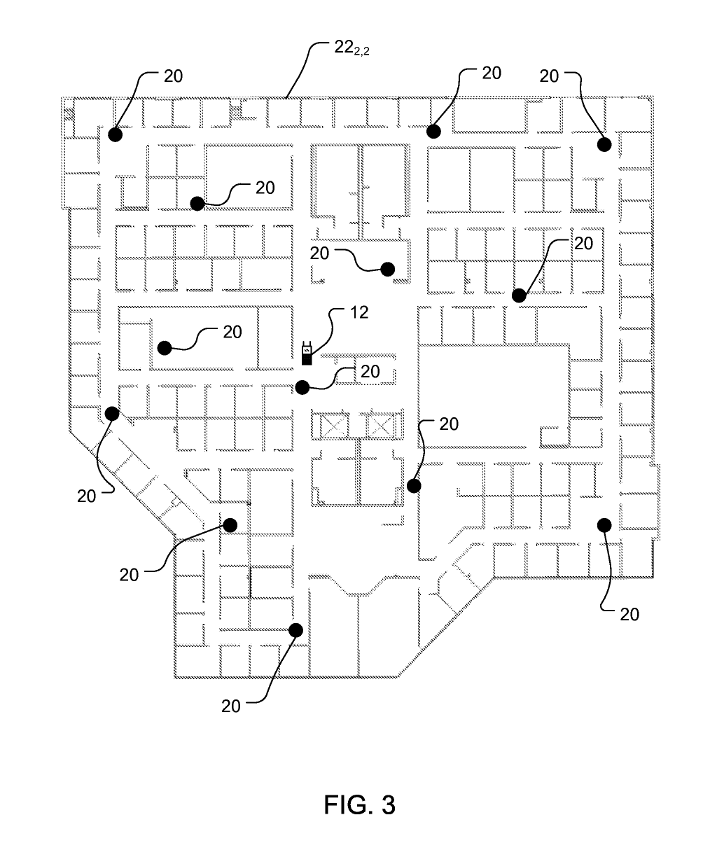

As shown in FIG. 3, a single floor, here the second floor 22_{2,2} of the structure 20₂, may contain many access points 20 distributed throughout the floor 22_{2,2}. A heatmap for the floor will indicate signal strength expected to be received at various locations throughout the floor 22_{2,2} from each of the access points 20. The mobile device 12 may take multiple measurements, for example at different locations, of access point beacon signals to help improve the heatmap, and multiple mobile devices may take access point beacon signal measurements in order to crowdsource information for producing and improving/modifying the heatmap. Due to the numerous access points 20, to avoid or reduce interference, one or more of the access points 20 may transmit beacon signals on different channels available for communication between the access points 20 and the mobile device 12. The mobile device 12 may provide information to the server, for example through the APs 20 or the BTSs 14, and the network 16, regarding channels used by the APs 20. The server 18 is configured to analyze the information and provide information regarding frequency of use of channels to the mobile device, for example through the APs 20.

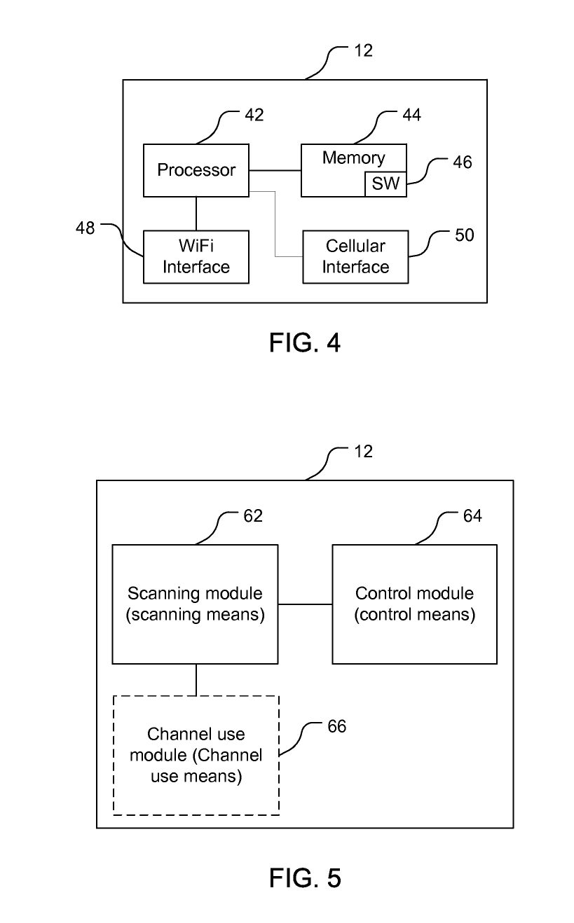

Referring to FIG. 4, the mobile device 12 comprises a computer system including a processor 42, a memory 44 including software 46, a WiFi interface 48, and a cellular interface 50. The processor 42 is preferably an intelligent hardware device, for example a central processing unit (CPU) such as those made by ARM®, Intel® Corporation, or AMD®, a microcontroller, an application specific integrated circuit (ASIC), etc. The processor 42 could comprise multiple separate physical entities that can be distributed in the mobile device 12. The memory 44 includes random access memory (RAM) and read-only memory (ROM). The memory 44 is a processor-readable storage medium that stores the software 46 which is processor-readable, processor-executable software code containing instructions that are configured to, when executed, cause the processor 42 to perform various functions described herein (although the description may refer only to the processor 42 performing the functions). Alternatively, the software 46 may not be directly executable by the processor 42 but configured to cause the processor 42, for example when compiled and executed, to perform the functions. The processor 42 is communicatively coupled to each of the memory 44, the WiFi interface 48, and the cellular interface 50. The WiFi interface 48 is configured to send signals/information to, and receive signals/information from, the access points 20 (FIG. 1) wirelessly. The cellular interface 50 is configured to send signals/information to, and receive signals/information from, the BTSs 14 wirelessly.

Referring to FIG. 5, the mobile device 12 includes a scanning module (scanning means) 62, a control module (control means) 64, and a channel use module (channel use means) 66. The modules 62, 64, 66 are functional modules implemented by the processor 42 and the software 46 stored in the memory 44, although the modules 62, 64, 66 could be implemented in hardware, firmware, or software, or combinations of these. Thus, reference to the modules 62, 64, 66 performing or being configured to perform a function is shorthand for the processor 42 performing or being configured to perform the function in accordance with the software 46 (and/or firmware, and/or hardware of the processor 42). Similarly, reference to the processor 42 scanning for beacon signals, controlling which WLAN channels to scan for beacon signals, or determining and/or reporting use of WLAN channels is equivalent to the scanning module 62, the control module 64, or the channel use module 66, respectively, performing the function. At least the module 66 is optional, and may be omitted from the mobile device 12.

The scanning module 62, or scanning means, is configured to scan WLAN channels for beacon signals from the APs 20. The scanning module 62 may actively or passively scan for beacon signals. The scanning module 62 may passively scan in order to obtain beacon signals from all APs 20 within communication range of the scanning module (whether the APs 20 are known to be within range or not), and more than one AP 20 per scan. A passive scan of all the WLAN channels may take approximately 1.2 seconds, consuming power of the mobile device 12. The scanning module 62 may scan WLAN channels as directed by the control module 64, which may reduce amounts of time and power used to scan WLAN channels, possibly without reducing the number of beacon signals received (for example in a single duration of scanning, or multiple durations of scanning), or not significantly reducing the number of beacon signals received. The scanning module 62 may passively scan each non-prevailing channel for less than 110 ms. The scanning module 62 scans channels to obtain information useful in determining position of the mobile device 12. For example, the scanning may identify signals, their sources, and corresponding RSSI values that may be used to determine the position of the mobile device 12 using trilateration. The scanning may also, or alternatively, yield other information useful in determining position. For example, travel times of beacon signals from APs 20 to the mobile device may be used to determine location. Travel times may be determined, for example, using received times of beacon signals according to a mobile device clock, transmit times according to access point clocks indicated in the beacon signals, and knowledge of timing differences (or lack thereof) of the mobile device clock and each access point clock.

The control module 64 is communicatively coupled to the scanning module 62 and is configured to control which WLAN channels the scanning module 62 scans for beacon signals. The control module 64 may determine which WLAN channels the scanning module 62 should scan in a variety of ways, for example based on frequency of use of the WLAN channels. The frequency of use of WLAN channels may be a frequency of use by APs 20 near the mobile device's present location, e.g., within a certain range of the mobile device 12, in a venue in which the mobile device 12 is presently disposed, on a floor of a building on which the mobile device 12 is presently disposed, combinations of these, etc. The control module 64 may also base which WLAN channels the scanning module 62 should scan on one or more available resources such as power available for use in scanning, time available for use in scanning, etc.

The control module 64 may obtain information as to the frequency of use of WLAN channels. For example, the control module 64 may access stored information in the memory 44 as to WLAN channels and associated frequencies of use. The frequency need not be explicit (i.e., an indicated number of occurrences per an indicated duration), but may be implicit, for example by providing a number of occurrences without providing an indication of duration for those occurrences, by providing indications of relative frequency without a specified actual frequency (see Tables 1-3 below), by providing indications of priority of channel scanning (see Table 4 below), etc. Explicit frequencies of use information may indicate actual frequencies of use (e.g., number of uses per a time period, average uses per a time period, etc.). Implicit frequencies of use information do not indicate actual frequencies of use, but provide other information such as indications of relative use of channels. Further, implicit indications of frequency may not provide indications of amounts of difference in frequency of use of different channels, but perhaps only an order of frequency of use of the channels. Examples of indications of relative use include a ranking of WLAN channels in order of frequency of use (see Table 4 below), or multipliers indicative of frequencies of use of channels relative to a reference frequency value (Table 1) or relative to one or more of the other channels (Table 2).

TABLE 1

| | Frequency |
|---|---|
| WLAN Channel | Multiplier |
| 1 | 1.1 |
| 2 | 0.07 |
| 3 | 0.04 |
| 4 | 0.02 |
| 5 | 0.09 |
| 6 | 0.9 |
| 7 | 0.04 |
| 8 | 0.02 |
| 9 | 0.02 |
| 10 | 0.02 |
| 11 | 0.85 |

In the example of Table 1, WLAN channel 1 is used 1.1 times more often than a reference frequency of 15,000 uses per month. Further, WLAN channels 2-11 are used, respectively, 0.07, 0.04, 0.02, 0.09, 0.9, 0.04, 0.02, 0.02, 0.02, 0.85 times the reference frequency.

TABLE 2

| | Frequency |
|---|---|
| WLAN Channel | Multiplier |
| 1 | 1.0 |
| 2 | 0.06 |
| 3 | 0.03 |
| 4 | 0.01 |
| 5 | 0.08 |
| 6 | 0.82 |
| 7 | 0.03 |
| 8 | 0.01 |
| 9 | 0.01 |
| 10 | 0.01 |
| 11 | 0.76 |

In the example of Table 2, WLAN channel 1 is used as a reference, and the frequency of use of WLAN channel 1 may or may not (as here) be provided. In this example, WLAN channels 2-11 are used, respectively, 0.06, 0.03, 0.01, 0.08, 0.82, 0.03, 0.01, 0.01, 0.01, 0.76 times as often as WLAN channel 1. Table 2 may be an example of frequency of use for WLAN channels in the United States, where WLAN channels 1, 6, and 11 are typically used due to the separation in their respective center frequencies, and corresponding lack of overlap. In other regions, where other channels are used as prevailing channels (primary channels used due to lack of overlap), the distributions of frequency of use may be very different. For example, Table 3 is an example of a possible frequency of use distribution in a region, for example Korea, where WLAN channels 1, 5, 9, and 13 are the prevailing channels.

TABLE 3

| | Frequency |
|---|---|
| WLAN Channel | Multiplier |
| 1 | 1.0 |
| 2 | 0.06 |
| 3 | 0.03 |
| 4 | 0.05 |
| 5 | 0.82 |
| 6 | 0.09 |
| 7 | 0.03 |
| 8 | 0.02 |
| 9 | 0.93 |
| 10 | 0.09 |
| 11 | 0.02 |
| 12 | 0.04 |
| 13 | 0.89 |

An example of a ranking of WLAN channels in order of frequency of use is provided in Table 4

TABLE 4

| | | Prevailing/Non- |
|---|---|---|
| WLAN Channel | Priority | prevailing |
| 1 | 1 | yes |
| 2 | 5 | no |
| 3 | 6 | no |
| 4 | 10 | no |
| 5 | 4 | no |
| 6 | 2 | yes |
| 7 | 7 | no |
| 8 | 11 | no |
| 9 | 8 | no |
| 10 | 9 | no |
| 11 | 3 | yes |

In Table 4, indications are provided for the priority order in which channels should be selected for scanning. Indications are also provided as to whether a channel is a prevailing or non-prevailing channel. This information may be used if the control module 64 applies multi-tiered prioritizing. For example, the control module 64 may cause the scanning module 62 to scan one prevailing channel and two non-prevailing channels, and may use Table 4 to select channels 1, 5, and 2 as channel 1 is the highest-priority prevailing channel and channels 5 and 2 are the highest-priority and second-highest-priority non-prevailing channels. The frequency of use, at least in order of frequency, is implied by the priority number. Further information may be provided to further imply the actual relative frequencies of use of the channels. For example, priority values may be assigned corresponding to relative uses as shown in Table 5.

TABLE 5

| | | Prevailing/Non- |
|---|---|---|
| WLAN Channel | Priority | prevailing |
| 1 | 1 | yes |
| 2 | 86 | no |
| 3 | 92 | no |
| 4 | 101 | no |
| 5 | 84 | no |
| 6 | 4 | yes |
| 7 | 94 | no |
| 8 | 11 | no |
| 9 | 95 | no |
| 10 | 95 | no |
| 11 | 6 | yes |

In this example, the priority number is not an order of selection, but an indication of priority for use for scanning, such that the control module 64 may select the channels for scanning at rates corresponding to their relative priorities. Thus, if a non-prevailing channel had a high priority (implying a high frequency of use), possibly approaching that of a prevailing channel, and the next-highest-priority non-prevailing channel's priority number was much lower, then the control module 64 may select that non-prevailing channel for scanning much more often than then next-highest-priority non-prevailing channel.

Alternatively, indications of frequency of use of WLAN channels may not include all of the available WLAN channels. For example, the prevailing channels may not be included, and only indications of frequencies of use of non-prevailing channels provided. This may be, for example, because the prevailing channels will always or nearly always be scanned, and thus using only information regarding the frequencies of use of non-prevailing channels, it can be determined which of the non-prevailing channels to scan. Thus, for example, information for channels 1, 6, and 11 may be omitted from Tables 1, 2, 4, or 5, or information for channels 1, 5, 9, and 13 omitted from Table 3. For Table 2, the frequency of use of the highest frequency of use non-prevailing channel may be used as the reference frequency. For Table 4, the priorities may start at 1, but simply end at 8, with only the non-prevailing channels being given a priority number.

Information regarding frequency of use of the WLAN channels may be stored before entrance into or approaching a region and/or upon or after entrance into or approaching a region. For example, prevailing channels may be stored for each of various regions, for example countries, and the control module 64 can retrieve the prevailing channel numbers using knowledge of the mobile device's present location, at least at the resolution of the stored prevailing channels (for example at the country resolution level). Frequency of use information may be received by the mobile device 12, for example by the control module 64. This pre-stored information may be stored in memory and/or hard-wired into the mobile device 12. Such pre-stored frequency of use information may be supplemented with frequency of use information on the go, for example as the mobile device 12 enters a smaller region such as a venue or building. Alternatively, the mobile device 12 may not have pre-stored frequency of use information and the control module 64 may obtain such information only upon or after approaching or entering a region. The control module 64 may receive frequency of use information from the server 18 through, for example, one or more of the APs 20 and/or from one or more of the BTSs 14. Thus, the control module 64 may obtain frequency of use information when the mobile device 12 is in communication range of an AP 20 and/or a BTS 14, for example as the mobile device 12 enters or approaches a building containing the AP 20. For example, the mobile device 12 may receive Table 1 from one or more of the APs 20 on the floor 22_{2,2} shown in FIG. 3, for example after exiting an elevator on the floor 22_{2,2}. The frequency of use information may be sent from the server 18 to the mobile device via an AP 20 and/or a BTS 14.

The control module 64 may analyze the frequency of use information for the WLAN channels to control the scanning module 62 to scan WLAN channels for beacon signals from the APs 20. For example, the control module 64 may determine the order of channels in terms of frequency of use, or may determine groups of frequency of use of channels (e.g., high frequency, medium frequency, and low frequency). The control module 64 may control the scanning module 62 to passively scan for beacon signals from the APs 20 based on the frequencies of use such that less than all of the usable WLAN channels are scanned. For example, the control module 64 may cause the scanning module 62 to scan at least one of the prevailing channels and at least one of the non-prevailing channels. The control module 64 may also cause the scanning module to scan all of the usable WLAN channels. For example, it may be desirable to scan all of the WLAN channels at times, for example with a desired frequency which may be at specific recurring times (for example noon each day) or not (for example once per day without a specific required time for collection). Whether less than all or all of the usable WLAN channels are to be scanned, the control module 64 may prioritize the order in which the scanning module 62 will scan the WLAN channels.

The control module 64 may also analyze information other than frequency of use to control the scanning module 62 to scan WLAN channels for beacon signals from the APs 20. For example, the control module 64 may determine an amount of power allocated for a beacon signal scan and/or an amount of time allocated (for example available or desirable) for a beacon signal scan. The amount of time allocated for beacon signal scanning may depend on various parameters such as, for example, present demands on the processor 42, frequency of use of non-prevailing channels in the present region of the mobile device 12, recent history of beacon signal scanning by the mobile device (for example with less time being allocated if the recent history has shown little or no beacon signals on one or more scanned channels). The amount of time or power available or desirable may vary over time, for example depending upon present demands on the processor 42 or desired data collection.

The control module 64 may use the analyzed information, regarding frequency of use of the WLAN channels and other parameters, to control which WLAN channels the scanning module 62 scans in a variety of manners. The control module 64 may select a subset of the usable WLAN channels for scanning, and may preselect the subset of channels or select the subset of channels in real time. For example, the control module 64 may preselect the list of channels to scan by producing a list of WLAN channels to scan and instructing the scanning module 62 to scan the list of WLAN channels until passive scanning of the list of WLAN channels is complete. Alternatively, the control module 64 may instruct the scanning module 62 to scan all of the WLAN channels, or a list of WLAN channels, and instruct the scanning module 62 to terminate passive scanning in response to an available/desirable resource limit (for example a time limit) being reached. In this case, the subset of channels selected contains those channels for which passive scanning was performed, preferably completed. A time limit being reached could be actual full expiry of a time period, or a time being reached where there is insufficient time remaining in the time period to complete the next passive channel scan.

The control module 64 may select a subset of channels for passive scanning in a variety of manners. For example, the control module 64 may select the prevailing channels, plus a fixed number of non-prevailing channels for scanning. The fixed number of non-prevailing channels may be arbitrarily selected, may be dependent upon an allocated resource (for example time for passive scanning), may be different over time, etc. Which non-prevailing channels are included in the fixed number of non-prevailing channels may be based on the frequency of use of the non-prevailing channels, for example with the N-most-frequently used non-prevailing channels being selected if N is the fixed number of non-prevailing channels to be scanned. Alternatively, the control module 64 may select one or more of the non-prevailing channels independent of frequency of use, for example randomly, in a pattern (for example sequentially by channel number), etc. For example, the control module 64 may select the non-prevailing channels such that all the non-prevailing channels are selected periodically (for example with a minimum frequency of selection), or are selected in response to a request, etc. Alternatively still, the number of non-prevailing channels may not be fixed. For example, all non-prevailing channels having a frequency of use over a threshold frequency may be selected for scanning The threshold frequency could be an absolute number (for example 1,000 uses per month) or a relative number (e.g., 0.05 times the frequency of the most-frequently used channel in the present region of the mobile device 12, 0.1 times the frequency of the least-frequently-used prevailing channel in the present region of the mobile device 12, etc.).

The following are non-limiting examples of the control module 64 selecting channels for scanning using the Tables 1-5. Referring to Table 2, for a threshold frequency of 0.05 times the frequency of the most-frequently used channel in the present region of the mobile device 12 (i.e., with a threshold frequency multiplier of 0.05 or higher for a non-prevailing channel), channels 2 and 5 (with relative frequencies of 0.06 and 0.08 times the most-frequently used channel) would be the non-prevailing channels to be passively scanned. For the same threshold but using Table 1, the threshold frequency multiplier would be 0.055, and again channels 2 and 5 would be chosen as the non-prevailing channels to scan. For the same threshold but using Table 3 (i.e., if the mobile device 12 is in Korea), channels 2, 4, 6, and 10 would be the chosen non-prevailing channels. Referring to Table 4, if the six most frequently used channels are to be scanned (i.e., N=6), then channels 1, 6, 11, 5, 2, and 3 (with priorities 1-6) would be scanned. For the same threshold but referring to Table 1, channels 1, 6, 11, 5, 2, and either 3 or 7 (because the frequency multipliers are equal) would be scanned. To select between channels 3 and 7, the control module 64 could select the channel with the higher frequency multiplier (if more specificity than is shown in Table 1 is available), may randomly select one of the channels, may alternate which channel is selected over multiple scans, etc. Referring to Table 5, if a priority of 96 is chosen, then channels with an equal or lower priority number would be scanned, in this example channels 1, 6, 11, 8, 2, 5, 3, 7, 9, 10 (with only channel 4 not being scanned). Channels may or may not be scanned in order of their priority or frequency of use. For example, once the channels to be scanned are determined, they may be scanned in order of their channel number.

The channel use module 66 is communicatively coupled to the scanning module 62 and is configured to collect and provide information regarding on which WLAN channels the scanning module 62 does and does not receive beacon signals. The channel use module monitors the scanning activity of the scanning module 62 to determine which WLAN channels are scanned and when, whether a beacon signal was detected for each scan, and an identifier (such as a media access control (MAC) address) for the corresponding AP 20 for each beacon signal received. The channel use module 66 may provide channel use information regarding scanned channels, whether beacon signals are received, and MAC addresses corresponding to received beacon signals. The channel use information provided by the channel use module 66 may be raw data (e.g., locations, channel, time, whether beacon signal received) or processed data/statistics (e.g., location, channel, frequency of use over specified duration (for example 5 hours), etc.) or specified time (for example noon to 5 PM on Jun. 1, 2014). The channel use module 66 may provide the channel use information to the server 18, e.g, via the WiFi interface 48 and one or more APs 20, via the cellular interface 50 and one or more BTSs 14, etc.

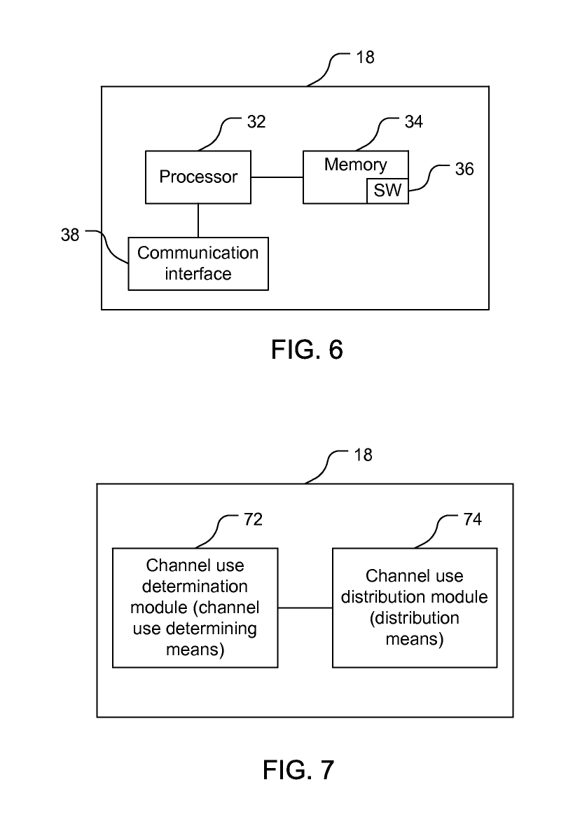

Referring to FIG. 6, the server 18 comprises a computer system including a processor 32, a memory 34 including software 36, and a communication interface 38. The processor 32 is preferably an intelligent hardware device, for example a central processing unit (CPU) such as those made by ARM®, Intel® Corporation, or AMD®, a microcontroller, an application specific integrated circuit (ASIC), etc. The processor 32 could comprise multiple separate physical entities that can be distributed in the server 18. The memory 34 includes random access memory (RAM) and read-only memory (ROM). The memory 34 is a processor-readable storage medium that stores the software 36 which is processor-readable, processor-executable software code containing instructions that are configured to, when executed, cause the processor 32 to perform various functions described herein (although the description may refer only to the processor 32 performing the functions). Alternatively, the software 36 may not be directly executable by the processor 32 but configured to cause the processor 32, for example when compiled and executed, to perform the functions. The processor 32 is communicatively coupled to each of the memory 34, and the communication interface 38. The communication interface 38 is configured to send information to, and receive information from, the mobile devices 12, for example, via the network 16 (FIG. 1). As discussed more fully below, the processor 32 may compile and analyze information regarding received beacon signals and produce and provide statistics and/or other indications of frequency of use of channels by the access points 20 for transmitting beacon signals.

Referring to FIG. 7, the server 18 includes a channel use determination module (channel use determining means) 72, and a channel use distribution module (distribution means) 74. The modules 72, 74 are functional modules implemented by the processor 32 and the software 36 stored in the memory 34, although the modules 72, 74 could be implemented in hardware, firmware, or software, or combinations of these. Thus, reference to the modules 72, 74 performing or being configured to perform a function is shorthand for the processor 32 performing or being configured to perform the function in accordance with the software 36 (and/or firmware, and/or hardware of the processor 32). Similarly, reference to the processor 32 determining channel use, or distributing channel use information is equivalent to the channel use module 72 or the channel use distribution module 74, respectively, performing the function.

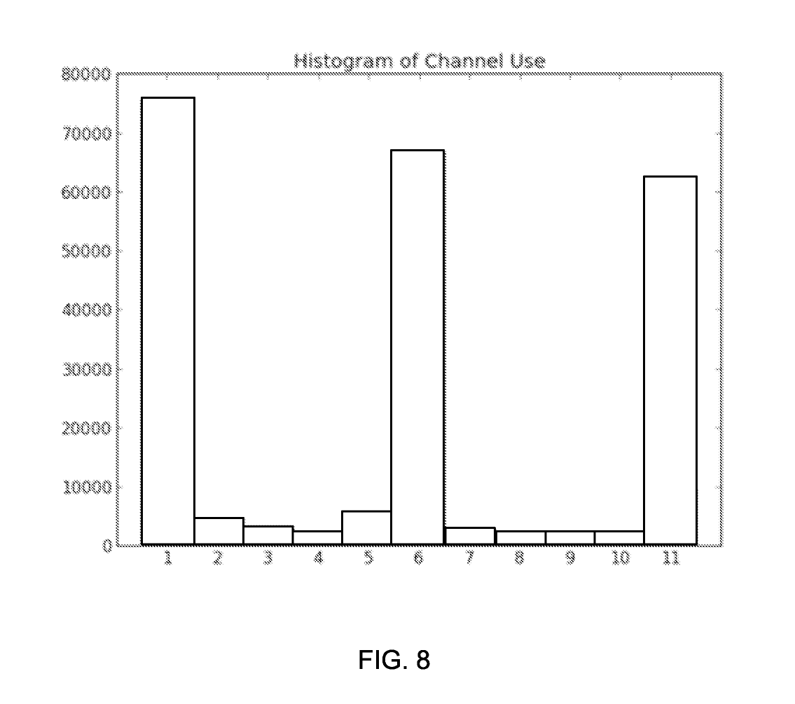

The channel use determination module 72 may compile channel use information from multiple mobile devices 12 to crowdsource WLAN channel use, in particular frequency of WLAN channel use. The module 72 collects information from the mobile devices 12, for example through the communication interface 38 from the channel use modules 66. The information from the mobile devices 12 may include raw data indicating locations of the mobile devices 12, what WLAN channels were scanned, when each channel was scanned, whether a beacon signal or other signal was received during each scan, and a MAC address for the source AP 20 for each received beacon signal. Also or alternatively, the channel use information from one or more of the mobile devices 12 may be pre-processed data indicative of frequency of use of channels. The module 72 may process the raw data and/or pre-processed data to determine frequency of use of WLAN channels. As shown in FIG. 8, frequency of use data may be provided as a number of occurrences as collected over some duration, whether that duration is indicated or not. The determined frequency of use data may be formatted in a variety of manners, such as shown FIG. 8 or in Tables 1-5, or in other formats. Indeed, Table 5 is derived from the same data as FIG. 8. The module 72 may compile and process the channel use data into a format that removes the actual frequency data, for example a format that provides a ranking of channels as to desired order of use and/or how often scanning of the channels is desired. Further, the module 72 may compile the frequency of use data for specific point locations and/or for location regions. Location regions may be any desired collection of point locations or any desired boundary such as floors of a building, entire buildings, groups of buildings (e.g., an airport, a college or corporate campus, etc.), geographic regions (e.g., zip codes, calling codes, cities, states, countries, etc.), etc.

The channel use determination module 72 preferably determines frequency of use of the WLAN channels as frequencies of beacon signal transmissions on the WLAN channels. That is, the module 72 preferably determines frequencies of unique beacon signal transmissions such that the same beacon signal (i.e., the identical beacon signal, from one of the APs 20 sent at a particular time) is counted only once even if received by multiple mobile devices 12 (and/or received multiple times, for example due to multipath). Multiple beacon signals from a single one of the APs 20 will be counted multiple times, once for each unique transmission. The module 72 may exclude multiple receptions of the same beacon signal by analyzing the transmission time and/or the receipt time of the beacon signal, as well as an identifier (for example, MAC address) of the AP 20 contained in the beacon signal. Excluding such multiple receptions may help accurately reflect actual channel use, eliminating counting reception of the same beacon signal by multiple mobile devices as multiple uses of the channel.

The number of channel uses indicated in FIG. 8 were measured in an experiment over a period of four months. It was found in this experiment that 15% of APs 20 used a non-prevailing channel at least once. It was further found that about half of the APs 20 changed their used channels at least once over the four months (although more of the APs 20 may have changed channels, without those changes being detected). It was further found that beacon signals from approximately 4% of the APs 20 were received on both prevailing channels and non-prevailing channels.

The channel use distribution module 74 may distribute the channel use information determined by the channel use determination module 72. The distribution module 74 may send information in any of a variety of formats to the APs 20 and/or BTSs 14. The APs 20 may provide the channel use information, for example a list of channels and corresponding frequency indications, to the mobile device(s) 12 within range of the APs 20. The frequency indications, as discussed above, may be explicit or implicit.

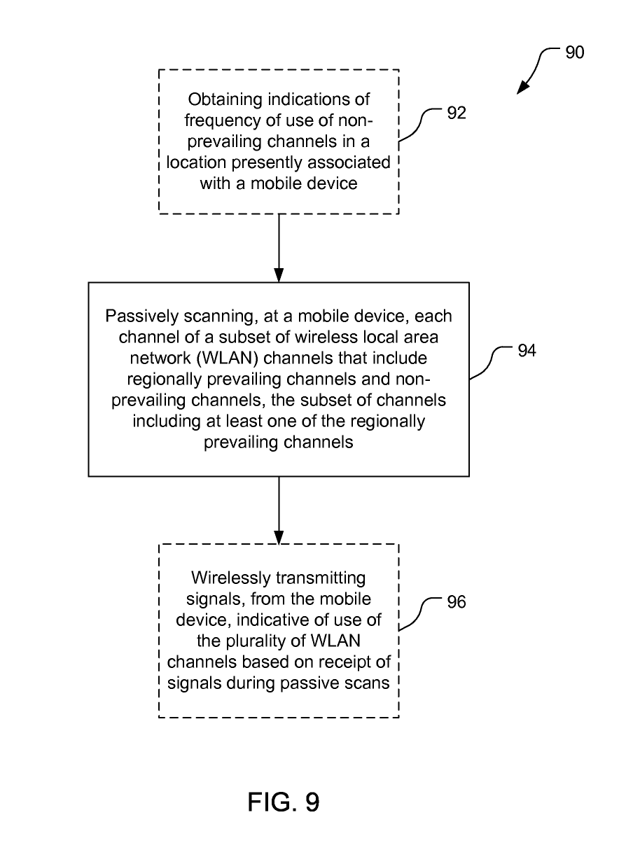

Referring to FIG. 9, with further reference to FIGS. 1-8, a process 90 of scanning WLAN channels at a mobile device (for example, for determining location information of the mobile device) includes the stages shown. The process 90 is, however, an example only and not limiting. The process 90 can be altered, for example by having stages altered, added, removed, combined, and/or performed concurrently. For example, stages 92 and 96 discussed below are optional stages and may be omitted.

At stage 92, the process 90 includes obtaining indications of frequency of use of non-prevailing WLAN channels in a location presently associated with a mobile device. For example, the channel use distribution module 74 of the server 18 may send frequency of channel use indications, and the mobile device 12 may receive the indications through the WiFi interface 48 from one or more of the APs 20 in a vicinity of the mobile device 12. The indications may include indications of frequency of use of the prevailing channels as well. The indications may be in any of a variety of forms, such as in the form of one or more lists according to one or more of Tables 1-5.

At stage 94, the process 90 includes passively scanning, at the mobile device, each channel of a subset of WLAN channels that include prevailing channels and non-prevailing channels, the subset of channels including at least one of the prevailing channels. The passively scanning is preferably continued for the channels of the subset of channels regardless of any detected beacon during passive scanning of a channel of the subset of channels. For example, the scanning module 62 passively scans one or more of the WLAN channels. The scanning module 62 may scan at least one of the non-prevailing channels as part of the subset of channels, and may passively scan a non-prevailing channel for less than 110 ms.

The scanning module 62 may passively scan particular WLAN channels based on the indications of frequency of use of the non-prevailing channels received during stage 92. For example, the scanning module 62 may include in the subset of channels the most-frequently-used non-prevailing channel according to the indications received of the frequency of use of channels in a location presently associated with the mobile device 12. The scanning module 62 may include in the subset of channels all of the prevailing channels and the N most-frequently-used non-prevailing channels according to the indications, where N is an integer greater than one and less than a total number of the non-prevailing channels. Thus, for example, the scanning module 62 may scan the prevailing channels and the three most-frequently used of the non-prevailing channels. The number of non-prevailing channels scanned may vary between scans. The number N may be determined based on an available or allocated amount of time for scanning and the time used to scan each channel. For example, if 500 ms is allotted for passive scanning, and each channel is scanned for 110 ms, then N may be set to one. The scanning module 62 may passively scan a particular one of the non-prevailing channels only if the particular one of the non-prevailing channels has a frequency of use greater than a threshold frequency of use. Thus, even if an allotted time for scanning would accommodate scanning of a (or another) non-prevailing channel, the scanning module 62 may scan that channel only if the frequency of use of that channel is at least as high as a threshold frequency of use.

Even if frequency of use of channels is known, the scanning module 62 may scan a less-frequently used channel and not scan a more-frequently used channel. For example, one or more of the prevailing channels may not be scanned. As another example, a random non-prevailing channel may be scanned regardless of frequency of use. As another example, one or more non-prevailing channels with lower frequency of use may intentionally be scanned while one or more non-prevailing channels of higher frequency of use are not scanned. Further, all channels may be scanned, preferably only occasionally, for example in response to entering a building or other region.

Which channels are scanned may vary. For example, the scanning module 62 may usually scan the N most-frequently used non-prevailing channels but occasionally also scan one of the non-prevailing channels that is not part of the N most-frequently used non-prevailing channels. As another example, the scanning module 62 may typically scan all the prevailing channels, but occasionally omit one or more of the prevailing channels from the scanned channels. This list of examples is not exhaustive, as countless variations of channel scanning variance are possible.

At stage 96, the process 90 includes wirelessly transmitting signals, from the mobile device, indicative of use of the plurality of WLAN channels based on receipt of signals during passive scans. The channel use module 66 collects information regarding channel use and wirelessly transmits this information, for example to one or more of the BTSs 14 and/or one or more of the APs 20. For example, the channel use module 66 may determine which channels were passively scanned, on which channel at least one beacon signal was received, and/or what MAC address(es) was(were) found on each passively scanned channel on which at least one beacon signal was received. From this information, a frequency of use histogram may be produced. The information is sent to the server 18, where the channel use determination module 72 aggregates the information, in particular the information regarding the MAC addresses found, from multiple mobile devices 12 to determine channel use frequency. The module 66 may also send information as to non-use of the channels, especially the non-prevailing channels, so that an accurate assessment of frequency of use may be determined If only channel use is reported, then the frequency of use of a channel may be inaccurately determined, for example if the channel is scanned relatively few times.

The process 90 may further include selecting the subset of channels before passively scanning any of the subset of channels, or defining the subset of channels by terminating the passively scanning, after the subset of channels has been passively scanned, in response to a time available for passively scanning expiring. The scanning module 62 may predetermine how many channels to scan before scanning, for example if the scanning module 62 knows an allocated amount of time for scanning. Alternatively, the scanning module 62 may scan channels until instructed to stop scanning, or until the module 62 determines that there is insufficient time to scan another channel, etc.

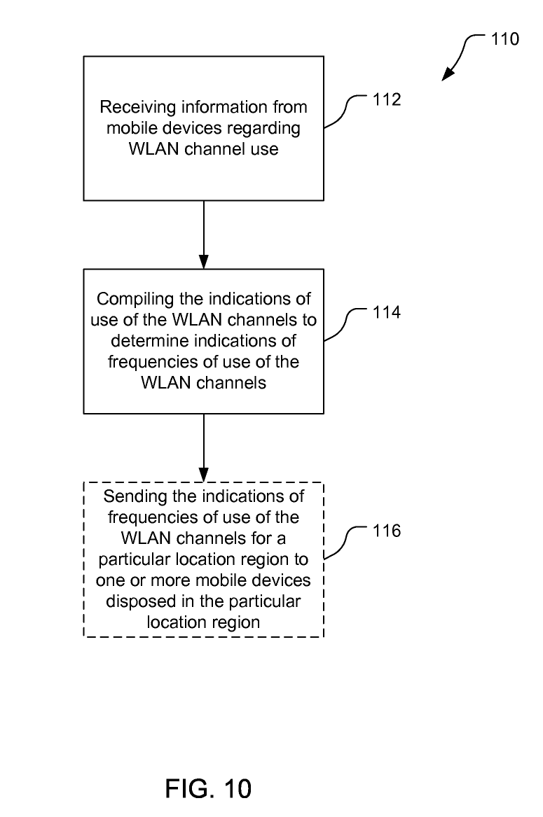

Referring to FIG. 10, with further reference to FIGS. 1-8, a process 110 of determining crowd-sourced WLAN channel frequency of use includes the stages shown. The process 110 is, however, an example only and not limiting. The process 110 can be altered, for example by having stages altered, added, removed, combined, and/or performed concurrently. For example, stage 116 discussed below is an optional stage and may be omitted.

At stage 112, the process 110 includes receiving information from mobile devices regarding WLAN channel use. In some implementations, the information can be aggregated from more than one mobile device, and in particular, a large number of mobile devices, such as hundreds or thousands of mobile devices. The communication interface 38 of the server 18 receives information from the mobile devices 12 indicating channel use, preferably of all the WLAN channels passively scanned by each of the mobile devices 12, but at least of the non-prevailing channels passively scanned by each of the mobile devices 12. The information from the mobile devices 12 may include the channel(s) scanned, when the channel(s) was(were) scanned, whether a beacon signal was received on each scanned channel, and if so, an identifier (for example, a MAC address) of the AP 20 that sent the beacon signal. The information may also include an indication of a transmission time of each beacon signal received.

At stage 114, the process 110 includes compiling the indications of use of the WLAN channels to determine indications of frequencies of use of the WLAN channels. The channel use determination module 72 collects the indications of use to determine frequencies of use of the WLAN channels, e.g., relative to each other (for example, Tables 2-3), as a prioritized list (for example, Tables 4-5), etc. Preferably, the frequencies of use of the WLAN channels are indicative of separate beacon signal transmissions on the WLAN channels. The indications of frequencies of use may be organized by location region as use frequency may vary by region (for example, by country, by building, by floor of building, by location on a floor of a building, etc.) for prevailing or non-prevailing channels, although prevailing channels typically only vary by country. The indications of frequency of use may take any of a variety of forms, e.g., Tables 1-5, similar tables but for only non-prevailing channels, etc. Tables may be provided for only non-prevailing channels, for example because the prevailing channels will be scanned and thus the particular frequency of use of each prevailing channel is irrelevant for determining which channels to scan and/or in which order.

At stage 116, the process 110 includes sending the indications of frequencies of use of the WLAN channels for a particular location region to one or more mobile devices disposed in the particular location region. The channel use distribution module 74 sends the frequency of use indications, for example one or more of Tables 1-5, etc., to one or more of the mobile devices 12 in a location region corresponding to the frequency of use indications sent. For example, the module 74 may send the indications in response to a request received from one or more of the mobile devices 12 (or one or more other devices, such as one or more of the APs 20), may send the indications intermittently (for example periodically) without receiving an external request to do so, etc. The one or more mobile devices 12 that receive the frequency of use indications can then determine which channels to scan and/or how often to scan them, for example as discusses above with respect to the process 90 shown in FIG. 9.

Other Considerations

As used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.).

As used herein, including in the claims, unless otherwise stated, a statement that a function or operation is “based on” an item or condition means that the function or operation is based on the stated item or condition and may be based on one or more items and/or conditions in addition to the stated item or condition.

Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Further, more than one invention may be disclosed.

Substantial variations to described configurations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Common forms of physical and/or tangible computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, EPROM, a FLASH-EPROM, any other memory chip or cartridge, a carrier wave as described hereinafter, or any other medium from which a computer can read instructions and/or code.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

A statement that a value exceeds (or is more than) a first threshold value is equivalent to a statement that the value meets or exceeds a second threshold value that is slightly greater than the first threshold value, for example the second threshold value being one value higher than the first threshold value in the resolution of a computing system. A statement that a value is less than (or is within) a first threshold value is equivalent to a statement that the value is less than or equal to a second threshold value that is slightly lower than the first threshold value, for example the second threshold value being one value lower than the first threshold value in the resolution of a computing system.

What is claimed is:

1. A mobile device capable of communication with wireless access points over a plurality of wireless local area network (WLAN) channels including prevailing channels corresponding to a region and non-prevailing channels corresponding to the region, the mobile device comprising:
a scanning module configured to passively scan each channel of a subset of channels for a beacon signal; and
a control module communicatively coupled to the scanning module and configured to control which channels the scanning module passively scans such that the subset of channels comprises multiple channels of the plurality of WLAN channels but less than all of the plurality of WLAN channels, and such that the subset of channels includes at least one of the prevailing channels.

2. The mobile device of claim 1 wherein the control module is configured to obtain indications of frequency of use of the non-prevailing channels in a location presently associated with the mobile device, and wherein the subset of channels includes the most-frequently-used non-prevailing channel according to the indications.

3. The mobile device of claim 2 wherein the scanning module is configured to passively scan all of the prevailing channels and the N most-frequently-used non-prevailing channels according to the indications, wherein N is an integer greater than one and less than a total number of the non-prevailing channels.

4. The mobile device of claim 2 wherein the control module is configured to receive a list of the non-prevailing channels and the indications of frequency of use of the non-prevailing channels.

5. The mobile device of claim 2 wherein the control module is configured to select a particular one of the non-prevailing channels for the scanning module to passively scan only if the particular one of the non-prevailing channels has a frequency of use greater than a threshold frequency of use.

6. The mobile device of claim 1 further comprising a channel use module, communicatively coupled to the scanning module, for determining and sending signals wirelessly from the mobile device indicating which of the plurality of WLAN channels the scanning module scanned, on which of the plurality of WLAN channels that were scanned the beacon signal was received, and a MAC address associated with each beacon signal that was received.

7. The mobile device of claim 1 further comprising channel indications stored in hardware that indicate the prevailing channels.

8. The mobile device of claim 1 wherein the subset of channels includes at least one of the non-prevailing channels and wherein the scanning module is configured to passively scan the at least one of the non-prevailing channels for less than 110 ms.

9. The mobile device of claim 1 wherein the scanning module is configured to continue passively scanning the channels of the subset of channels regardless of any detected beacon during scanning of a channel of the subset of channels

10. A mobile device capable of communication with wireless access points over a plurality of wireless local area network (WLAN) channels to obtain information for determining location information of the mobile device, the plurality of WLAN channels including prevailing channels corresponding to a region and non-prevailing channels corresponding to the region, the mobile device comprising:
scanning means for passively scanning each channel of a subset of channels for a beacon signal; and
control means, communicatively coupled to the scanning means, for controlling which channels the scanning means passively scans such that the subset of channels comprises multiple channels of the plurality of WLAN channels but less than all of the plurality of WLAN channels, and such that the subset of channels includes at least one of the prevailing channels.

11. The mobile device of claim 10 wherein the control means are configured to obtain indications of frequency of use of the non-prevailing channels in a location presently associated with the mobile device, and wherein the subset of channels includes the most-frequently-used non-prevailing channel according to the indications.

12. The mobile device of claim 11 wherein the scanning means are configured to passively scan all of the prevailing channels and the N most-frequently-used non-prevailing channels according to the indications, wherein N is an integer greater than one and less than a total number of the non-prevailing channels.

13. The mobile device of claim 11 wherein the scanning means are configured to passively scan a particular one of the non-prevailing channels only if the particular one of the non-prevailing channels has a frequency of use greater than a threshold frequency of use.

14. The mobile device of claim 10 further comprising channel use means, communicatively coupled to the scanning means, for determining and transmitting signals wirelessly from the mobile device indicative of which of the plurality of WLAN channels the scanning means scanned, on which of the plurality of WLAN channels that were scanned the beacon signal was received, and a MAC address associated with each beacon signal that was received.

15. The mobile device of claim 10 wherein the subset of channels includes at least one of the non-prevailing channels and wherein the scanning means are for passively scanning the at least one of the non-prevailing channels for less than 110 ms.

16. A method of scanning wireless local area network channels at a mobile device, the method comprising:
passively scanning, at the mobile device, each channel of a subset of channels for a beacon signal, the subset of channels comprising multiple, but less than all, of a plurality of wireless local area network (WLAN) channels, the plurality of WLAN channels including prevailing channels corresponding to a region and non-prevailing channels corresponding to the region, and the subset of channels including at least one of the prevailing channels.

17. The method of claim 16 further comprising obtaining indications of frequency of use of the non-prevailing channels in a location presently associated with the mobile device, wherein the subset of channels includes the most-frequently-used non-prevailing channel according to the indications.

18. The method of claim 17 wherein the passively scanning comprises passively scanning all of the prevailing channels and the N most-frequently-used non-prevailing channels according to the indications, wherein N is an integer greater than one and less than a total number of the non-prevailing channels.

19. The method of claim 17 wherein the passively scanning comprises passively scanning a particular one of the non-prevailing channels only if the particular one of the non-prevailing channels has a frequency of use greater than a threshold frequency of use.

20. The method of claim 17 wherein obtaining indications of frequency of use of the non-prevailing channels comprises receiving a list of the non-prevailing channels and the indications of frequency of use of the non-prevailing channels.

21. The method of claim 16 further comprising wirelessly transmitting signals, from the mobile device, indicative of which of the plurality of WLAN channels were scanned, on which of the plurality of WLAN channels that were scanned the beacon signal was received, and a MAC address associated with each beacon signal that was received.

22. The method of claim 16 wherein the subset of channels includes at least one of the non-prevailing channels and wherein the passively scanning comprises passively scanning the at least one of the non-prevailing channels for less than 110 ms.

23. The method of claim 16 further comprising at least one of:
selecting the subset of channels before passively scanning any of the subset of channels; or
defining the subset of channels by terminating the passively scanning, after the subset of channels has been passively scanned, in response to a time available for passively scanning expiring.

24. The method of claim 16 wherein the passively scanning is performed for all of the channels of the subset of channels regardless of any detected beacon during passive scanning of a channel of the subset of channels

25. A server for determining crowd-sourced wireless local area network (WLAN) channel frequency of use, the server comprising:
a communication interface configured to receive information from a plurality of mobile devices; and
a channel use determination module communicatively coupled to the communication interface and configured to:
receive, from the plurality of mobile devices via the communication interface, indications of use of WLAN channels including at least non-prevailing channels corresponding to a region;
compile the indications of use of the WLAN channels to determine indications of frequencies of use of the WLAN channels.

26. The server of claim 25 wherein the channel use determination module is configured to compile the indications of frequencies of use of the WLAN channels according to location regions.

27. The server of claim 26 further comprising a channel use distribution module communicatively coupled to the communication interface and to the channel use determination module and configured to send the indications of frequencies of use of the WLAN channels for a particular location region of the location regions to mobile devices disposed in the particular location region.

28. The server of claim 25 wherein the WLAN channels include prevailing channels corresponding to the region.

29. The server of claim 25 wherein the indications of frequencies of use comprise at least one of indications of frequencies of use of the WLAN channels relative to a reference frequency, indications of frequencies of use of the WLAN channels relative to a frequency of one of the WLAN channels, or a prioritized list of the WLAN channels.

30. The server of claim 25 wherein each of the indications of use of the WLAN channels includes an indication of the WLAN channel used, an indication of time of use of the WLAN channel, and an identifier of an access point from which a beacon signal was received on the WLAN channel, and wherein the channel use determination module is configured to determine the indications of frequencies of use of the WLAN channels such that the indications of frequencies of use of the WLAN channels represent frequencies of separate beacon signal transmissions on the WLAN channels.
